(19) United States
(12) Patent Application Publication
(10) Pub. No.: US 2020/0269689 A1
(43) Pub. Date: Aug. 27, 2020

(54) ECO-CRUISE: FUEL-ECONOMY OPTIMIZED CRUISE CONTROL

(71) Applicant: GM Global Technology Operations LLC, Detroit, MI (US)

(72) Inventors: Matthew S. Zebiak, Ann Arbor, MI (US); Amanpal S. Grewal, Novi, MI (US)

(73) Assignee: GM Global Technology Operations LLC, Detroit, MI (US)

(21) Appl. No.: 16/283,040

(22) Filed: Feb. 22, 2019

(51) Int. Cl. B60K 31/04; B60W 30/14

(52) U.S. Cl. CPC B60K 31/042; B60W 2710/083; B60W 30/146

(57) ABSTRACT

A method includes receiving a set speed, a maximum allowed speed, and a minimum allowed speed, wherein the maximum allowed speed and the minimum allowed speed define an allowed speed range; commanding a propulsion system to produce a commanded axle torque to maintain the set speed; monitoring a current vehicle speed of the vehicle; determining whether the current vehicle speed is between a first speed value and a second speed value, wherein the first speed value is the minimum allowed speed plus a first predetermined value, and the second speed value is the maximum allowed speed minus a second predetermined value; and in response to determining that the current vehicle speed is not between the first speed value and the second speed value, commanding the propulsion system to adjust the commanded axle torque in order to maintain the current vehicle speed within the allowed speed range.

### INTRODUCTION

The present disclosure relates to a method and system to control a cruise control of a vehicle to optimize fuel economy.

Cruise control is currently calibrated to rigidly control a driver's set speed, and can be aggressive and inefficient in its attempt to maintain that speed on changes in road grades. This leads to lower fuel economy and unnatural behavior (e.g., aggressive tip-ins and downshifts while going up hills, riding the brakes down hills, etc.).

### SUMMARY

The presently disclosed method delivers higher fuel economy to vehicles in cruise control by allowing the vehicle to module its speed in response to changing road grades. This method allows drivers to input a custom tolerance for deviations above and below their set speed, so steady state-engine operation and fuel economy are maximized within driver's individual preferences. The vehicle uses an axle torque request algorithm, which helps the vehicle trend towards the set speed on a flat road, limit torque requests during ascents, and preserve kinetic energy during descents.

The presently disclosed method may include an additional feature that allows torque output to react slightly while still delivering improvements in fuel economy. Doing so allows for an improvement in speed control and increased tolerance to road elevation changes. Torque is commanded in various stages depending upon speed error and speed error rate. The magnitude of marginal torque applied is based on an understanding of various efficiency modes and their capabilities. Torque can be added and removed in an efficient manner, by using a tiered structure that takes advantage of current available efficiency modes (Active Fuel Management (AFM), current gear, stoichiometric fueling, etc.). It therefore allows for intelligent torque modulation within the allowable speed bandwidth to reduce speed fluctuations while maximizing efficient operation.

In one aspect of the present disclosure, A method to control a vehicle includes receiving, by a controller of the vehicle, a set speed, a maximum allowed speed, and a minimum allowed speed, wherein the maximum allowed speed and the minimum allowed speed define an allowed speed range; commanding, by the controller, a propulsion system to produce a commanded axle torque to maintain the set speed; monitoring a current vehicle speed of the vehicle; determining, by the controller, whether the current vehicle speed is between a first speed value and a second speed value, wherein the first speed value is the minimum allowed speed plus a first predetermined value, and the second speed value is the maximum allowed speed minus a second predetermined value; and in response to determining that the current vehicle speed is not between the first speed value and the second speed value, commanding, by the controller, the propulsion system to adjust the commanded axle torque in order to maintain the current vehicle speed within the allowed speed range. Commanding the propulsion system to adjust the commanded axle torque includes determining whether the current vehicle speed is less than the first speed value; and in response to determining that the current vehicle speed is less than the first speed value, commanding the propulsion system to continuously increase the commanded axle torque until the vehicle reaches a third speed value, wherein the third speed value is equal to the minimum allowed speed plus a third predetermined value, and the third predetermined value is greater than the first predetermined value.

Determining, by the controller, whether the current vehicle speed is between the first speed value and the second speed value may include determining that the current vehicle speed is less than the first speed value. Commanding, by the controller, the propulsion system of the vehicle to adjust commanded axle torque to modify the current vehicle speed to be between the first speed value and the second speed value may include commanding the propulsion system to increase the commanded axle torque to a commanded torque that prevents the current vehicle speed to drop below the minimum allowed speed in response to determining that the current vehicle speed is less than the first speed value. The method may further include not allowing, by the controller, the commanded torque to decrease until the current vehicle speed is equal to or greater than a third speed value, the third speed value is equal to the minimum allowed speed plus a third predetermined value, and the third predetermined value is greater than the second predetermined value. Determining, by the controller, whether the current vehicle speed is between the first speed value and the second speed value and includes determining that the current vehicle speed is greater than the second speed value. The method may further include, in response to determining that the current vehicle speed is greater than the second speed value: commanding the propulsion system to stop producing additional torque; and commanding the propulsion system to employ deceleration fuel cut off (DFCO).

The method may further include charging a battery of the vehicle using regenerative braking in response to determining that the current vehicle speed is greater than the second speed value. The method may further include determining whether the vehicle is accelerating at a pace that will pass the fourth speed value after the propulsion system 20 has employed (i.e., activated) the DFCO. The fourth speed value is equal to the maximum allowed speed minus a fourth predetermined value, and the fourth predetermined value is less than the first predetermined value and the second predetermined value.

Determining whether the current vehicle speed is increasing past the fourth speed value after the propulsion system has employed the DFCO may include determining that the current vehicle speed is increasing past the fourth speed value, and the method further includes activating, by the controller, a brake system of the vehicle to prevent the vehicle from exceeding the maximum allowed speed in response to determining that the current vehicle speed is increasing past the fourth speed value.

The method may further include: determining that the current vehicle speed is equal to or less than the second speed value; and deactivating the brake system in response to determining that the current vehicle speed is equal to or less than the second speed value.

The present disclosure also describes a vehicle system including a sensor system. The sensor system includes a plurality of sensors. The vehicle system further includes a user interface configured to receive inputs and a propulsion system configured to propel the vehicle and a controller in communication with the sensor system and the user interface. The controller is programmed to execute the method described above.

The above features and advantages, and other features and advantages, of the present teachings are readily apparent from the following detailed description of some of the best modes and other embodiments for carrying out the present teachings, as defined in the appended claims, when taken in connection with the accompanying drawings.

### BRIEF DESCRIPTION OF THE DRAWINGS

FIG. 1 is a schematic block diagram of a vehicle.

FIG. 2 is schematic diagram of part of a user interface of the vehicle of FIG. 1.

FIG. 3 is a flowchart of a method for controlling the cruise control of the vehicle to optimize fuel economy.

### DETAILED DESCRIPTION

The following detailed description is merely exemplary in nature and is not intended to limit the application and uses. Furthermore, there is no intention to be bound by expressed or implied theory presented in the preceding technical field, background, brief summary or the following detailed description. As used herein, the term “module” refers to hardware, software, firmware, electronic control component, processing logic, and/or processor device, individually or in a combination thereof, including without limitation: application specific integrated circuit (ASIC), an electronic circuit, a processor (shared, dedicated, or group) and memory that executes one or more software or firmware programs, a combinational logic circuit, and/or other suitable components that provide the described functionality.

Embodiments of the present disclosure may be described herein in terms of functional and/or logical block components and various processing steps. It should be appreciated that such block components may be realized by a number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present disclosure may be practiced in conjunction with a number of systems, and that the systems described herein are merely exemplary embodiments of the present disclosure.

For the sake of brevity, techniques related to signal processing, data fusion, signaling, control, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that alternative or additional functional relationships or physical connections may be present in an embodiment of the present disclosure.

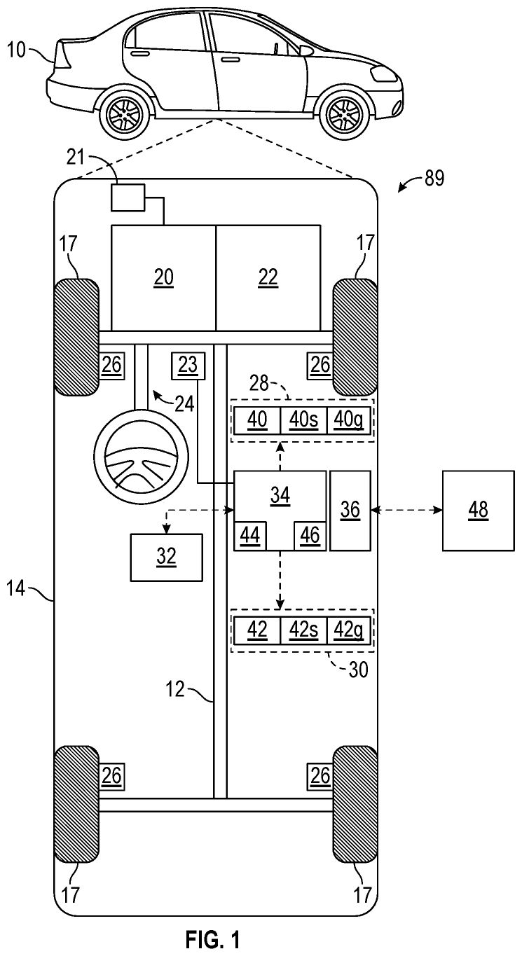

As depicted in FIG. 1, the vehicle 10 generally includes a chassis 12, a body 14, front and rear wheels 17 and may be referred to as the host vehicle. The body 14 is arranged on the chassis 12 and substantially encloses components of the vehicle 10. The body 14 and the chassis 12 may jointly form a frame. The wheels 17 are each rotationally coupled to the chassis 12 near a respective corner of the body 14.

In various embodiments, the vehicle 10 may be an autonomous vehicle and a control system 89 is incorporated into the vehicle 10. The control system 89 may alternatively be referred to as the vehicle system. The vehicle 10 is, for example, a vehicle that is automatically controlled to carry passengers from one location to another. The vehicle 10 is depicted in the illustrated embodiment as a passenger car, but it should be appreciated that another vehicle including motorcycles, trucks, sport utility vehicles (SUVs), recreational vehicles (RVs), marine vessels, aircraft, etc., can also be used. In an exemplary embodiment, the vehicle 10 is a so-called Level Four or Level Five automation system. A Level Four system indicates “high automation”, referring to the driving mode-specific performance by an automated driving system of the aspects of the dynamic driving task, even if a human driver does not respond appropriately to a request to intervene. A Level Five system indicates “full automation”, referring to the full-time performance by an automated driving system of the aspects of the dynamic driving task under different roadway and environmental conditions that can be managed by a human driver.

As shown, the vehicle 10 generally includes a propulsion system 20, a transmission system 22, a steering system 24, a brake system 26, a sensor system 28, an actuator system 30, at least one data storage device 32, at least one controller 34, and a communication system 36. The propulsion system 20 may, in various embodiments, include an electric machine such as a traction motor and/or a fuel cell propulsion system. The vehicle 10 further includes a battery (or battery pack) 21 electrically connected to the propulsion system 20. Accordingly, the battery 21 is configured to store electrical energy and to provide electrical energy to the propulsion system 20. Additionally, the propulsion system 20 may include an internal combustion engine. The transmission system 22 is configured to transmit power from the propulsion system 20 to the vehicle wheels 17 according to selectable speed ratios. According to various embodiments, the transmission system 22 may include a step-ratio automatic transmission, a continuously-variable transmission, or other appropriate transmission. The brake system 26 is configured to provide braking torque to the vehicle wheels 17. The brake system 26 may, in various embodiments, include friction brakes, brake by wire, a regenerative braking system such as an electric machine, and/or other appropriate braking systems. The steering system 24 influences a position of the of the vehicle wheels 17. While depicted as including a steering wheel for illustrative purposes, in some embodiments contemplated within the scope of the present disclosure, the steering system 24 may not include a steering wheel.

The sensor system 28 includes one or more sensing devices 40 that sense observable conditions of the exterior environment and/or the interior environment of the vehicle 10. The sensing devices 40 may include, but are not limited to, radars, lidars, global positioning systems, optical cameras, thermal cameras, ultrasonic sensors, and/or other sensors. The actuator system 30 includes one or more actuator devices 42 that control one or more vehicle features such as, but not limited to, the propulsion system 20, the transmission system 22, the steering system 24, and the brake system 26. In various embodiments, the vehicle features can further include interior and/or exterior vehicle features such as, but are not limited to, doors, a trunk, and cabin features such as air, music, lighting, etc. (not numbered). The sensing system 28 includes one or more Global Positioning System (GPS) transceiver 40g configured to detect and monitor the route data (i.e., route information). The GPS transceiver 40g is configured to communicate with a GPS to locate the position of the vehicle 10 in the globe. The GPS transceiver 40g is in electronic communication with the controller 34.

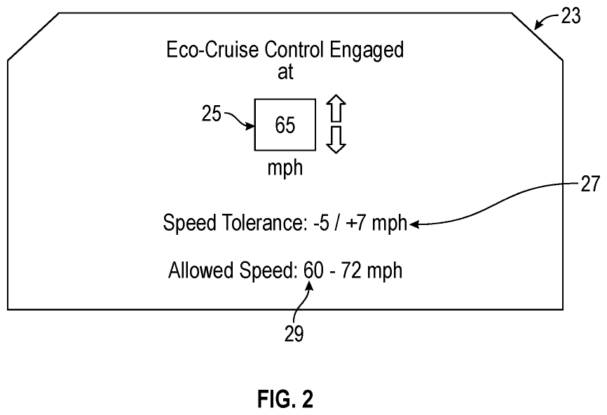

The data storage device 32 stores data for use in automatically controlling the vehicle 10. In various embodiments, the data storage device 32 stores defined maps of the navigable environment. In various embodiments, the defined maps may be predefined by and obtained from a remote system (described in further detail with regard to FIG. 2). For example, the defined maps may be assembled by the remote system and communicated to the vehicle 10 (wirelessly and/or in a wired manner) and stored in the data storage device 32. As can be appreciated, the data storage device 32 may be part of the controller 34, separate from the controller 34, or part of the controller 34 and part of a separate system.

The controller 34 includes at least one processor 44 and a computer non-transitory readable storage device or media 46. The processor 44 can be a custom made or commercially available processor, a central processing unit (CPU), a graphics processing unit (GPU), an auxiliary processor among several processors associated with the controller 34, a semiconductor-based microprocessor (in the form of a microchip or chip set), a macroprocessor, a combination thereof, or generally a device for executing instructions. The computer readable storage device or media 46 may include volatile and nonvolatile storage in read-only memory (ROM), random-access memory (RAM), and keep-alive memory (KAM), for example. KAM is a persistent or non-volatile memory that may be used to store various operating variables while the processor 44 is powered down. The computer-readable storage device or media 46 may be implemented using a number of memory devices such as PROMs (programmable read-only memory), EPROMs (electrically PROM), EEPROMs (electrically erasable PROM), flash memory, or another electric, magnetic, optical, or combination memory devices capable of storing data, some of which represent executable instructions, used by the controller 34 in controlling the vehicle 10.

The instructions may include one or more separate programs, each of which comprises an ordered listing of executable instructions for implementing logical functions. The instructions, when executed by the processor 44, receive and process signals from the sensor system 28, perform logic, calculations, methods and/or algorithms for automatically controlling the components of the vehicle 10, and generate control signals to the actuator system 30 to automatically control the components of the vehicle 10 based on the logic, calculations, methods, and/or algorithms. Although a single controller 34 is shown in FIG. 1, embodiments of the vehicle 10 may include a number of controllers 34 that communicate over a suitable communication medium or a combination of communication mediums and that cooperate to process the sensor signals, perform logic, calculations, methods, and/or algorithms, and generate control signals to automatically control features of the vehicle 10.

In various embodiments, one or more instructions of the controller 34 are embodied in the control system 89. The vehicle 10 includes a user interface 23, which may be a touchscreen in the dashboard. The user interface 23 is in electronic communication with the controller 34 and is configured to receive inputs by a user (e.g., vehicle operator). Accordingly, the controller 34 is configured to receive inputs from the user via the user interface 23. The user interface 23 includes a display configured to display information to the user (e.g., vehicle operator or passenger).

The communication system 36 is configured to wirelessly communicate information to and from other entities 48, such as but not limited to, other vehicles (“V2V” communication), infrastructure (“V2I” communication), remote systems, and/or personal devices (described in more detail with regard to FIG. 2). In an exemplary embodiment, the communication system 36 is a wireless communication system configured to communicate via a wireless local area network (WLAN) using IEEE 802.11 standards or by using cellular data communication. However, additional or alternate communication methods, such as a dedicated short-range communications (DSRC) channel, are also considered within the scope of the present disclosure. DSRC channels refer to one-way or two-way short-range to medium-range wireless communication channels specifically designed for automotive use and a corresponding set of protocols and standards. Accordingly, the communication system 36 may include one or more antennas and/or transceivers for receiving and/or transmitting signals, such as cooperative sensing messages (CSMs).

FIG. 1 is a schematic block diagram of the control system 89, which is configured to control the vehicle 10. The controller 34 of the control system 89 is in electronic communication with the braking system 26, the propulsion system 20, and the sensor system 28. The braking system 26 includes one or more brake actuators (e.g., brake calipers) coupled to one or more wheels 17. Upon actuation, the brake actuators apply braking pressure on one or more wheels 17 to decelerate the vehicle 10. The propulsion system 20 includes one or more propulsion actuators for controlling the propulsion of the vehicle 10. For example, as discussed above, the propulsion system 20 may include internal combustion engine and, in that case, the propulsion actuator may be a throttle specially configured to control the airflow in the internal combustion engine. The sensor system 28 may include one or more accelerometers (or one or more gyroscopes) coupled to one or more wheels 17. The accelerometer is in electronic communication with the controller 34 and is configured to measure and monitor the longitudinal and lateral accelerations of the vehicle 10. The sensor system 28 may include one or more speed sensors 40s configured to measure the speed (or velocity) of the vehicle 10. The speed sensor 40s is coupled to the controller 34 and is in electronic communication with one or more wheels 17.

FIG. 2 is a schematic diagram of part of the user interface 23. The vehicle 10 has cruise control, and the driver's set speed 25 (shown in the user interface 23) can be adjusted by the driver with, for example, up/down arrows on the steering wheel of the vehicle 10. Aside from the driver's set speed 25, the user interface 23 also shows the speed tolerance 27, which includes a maximum allowed speed and a minimum allowed speed. The driver may adjust the maximum allowed speed and and/or minimum allowed of the speed tolerance using the user interface 23. The user interface 23 shows the allowed speed range, which is calculated as a function of the set speed, the minimum allowed speed, and the minimum allowed speed.

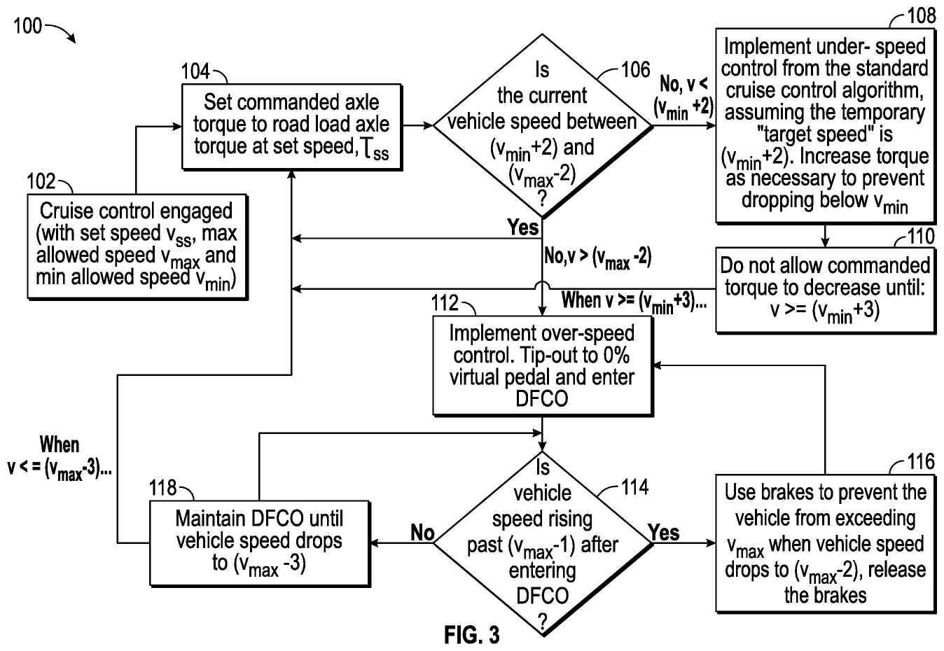

FIG. 3 is a flowchart of a method 100 for controlling the cruise control of the vehicle 10 to optimize fuel economy. The method 100 begins at 102. At block 102, the controller 34 determines the cruise control is engaged and receives the driver's set speed vₛₛ, the maximum allowed speed vₘₐₓ, and the minimum allowed speed vₘᵢₙ from the user interface 23. The maximum allowed speed vₘₐₓ and the minimum allowed speed vₘᵢₙ define the allowed speed range 29. User-calibratable thresholds give drivers more control on how the vehicle 10 operates in this fuel-saving mode. Then, the method 100 proceeds to block 104. At block 104, the controller 34 commands the propulsion system 20 to produce a commanded axle torque to maintain the set speed vₛₛ. Specifically, the controller 34 sets the commanded axle torque and the road load axle torque to achieve the set speed vₛₛ. Holding the axle torque constant at the set speed road load axle torque will ensure that transient losses, shifts, Active Fuel Management (AFM)/Deceleration Fuel Cut-Off (DFCO) transitions, and brake applications are minimized, and that the vehicle 10 will trend towards the set speed on a flat road. Activating the AFM causes the some or at least half of the engine cylinders of the vehicle 10 to be deactivated. Activating the DFCO stops the delivery of fuel to the engine of the vehicle 10. At block 104, the controller 34 also monitors the current vehicle speed of the vehicle 10 in real time using the inputs of one or more speed sensors 40s. Then, the method 100 proceeds to block 106.

At block 106, the controller 34 determines whether the current vehicle speed is between a first speed value and a second speed value. The first speed value is the minimum allowed speed vₘᵢₙ plus a first predetermined value (e.g., 2 mph), and the second speed value is the maximum allowed speed vₘₐₓ minus a second predetermined value (e.g., 2 mph). If the current vehicle speed is between the first speed value and the second speed value, then the method 100 returns to block 104. If the controller 34 determines that the current vehicle speed is less than the first speed value, then the method 100 continues to block 108.

At block 108, the controller 34 implements the under-speed control from cruise control algorithm, assuming the temporary “target speed” is the first speed value. At block 108, the controller 34 commands the propulsion system 20 to increase the commanded axle torque to cause the vehicle 10 to reach the first speed value, thereby preventing the current vehicle speed from dropping below the minimum allowed speed vₘᵢₙ. Then, the method 100 proceeds to block 110. At block 110, the controller 34 does not allow the commanded axle torque to decrease until the current vehicle speed is equal to or greater than a third speed value. At block 110, the controller 34 commands the propulsion system 20 to continuously increase the commanded axle torque until the vehicle 10 reaches the third speed value to make sure the vehicle speed stays within the allowed speed range 29. The third speed value is equal to the minimum allowed speed vₘᵢₙ plus a third predetermined value (e.g., 3 mph). The third predetermined value is greater than the second predetermined value to make sure to prevent violations of the driver's allowed speed range 29. After block 110, the method 100 returns to block 104 solely when the current vehicle speed is equal to or greater than the third predetermined value.

Returning to block 106, if the current vehicle speed is greater than the second speed value, then the method 100 proceeds to block 112. At block 112, the controller 34 implements an over-speed control. At block 112, the controller 34 commands the propulsion system 20 to tip-out at 0% virtual pedal (i.e., command the propulsion system to stop producing additional torque). Also, at block 112, the controller 34 commands the propulsion system 20 to employ (i.e., activate) deceleration fuel cut off (DFCO), thereby cutting the supply of fuel to the internal combustion engine of the propulsion system 20. At block 112, the controller 34 commands the battery 21 to be charged using regenerative braking in response to determining that the current vehicle speed is greater than the second speed value. Engaging DFCO and full battery regeneration near the top of the allowable speed range ensures that fuel is not wasted, and that excess kinetic energy is converted into a form that can be recovered and used later. After block 112, the method 100 proceeds to block 114.

At block 114, the controller 34 determines whether the current vehicle speed is increasing past a fourth speed value after the propulsion system 20 has employed (i.e., activated) the DFCO. In other words, the controller 34 determines whether the current vehicle speed is accelerating at a pace that will pass the fourth speed value after the propulsion system 20 has employed (i.e., activated) the DFCO. The fourth speed value is equal to the maximum allowed speed vₘₐₓ minus a fourth predetermined value. The fourth predetermined value is less than the first predetermined value, the second predetermined value, and the third predetermined value to ensure that the controller 34 reacts in time to prevent violations of the driver's allowed speed range 29. If the controller 34 determines that the current vehicle speed is increasing past the fourth speed value, then the method 100 proceeds to block 116. At block 116, the controller 34 activates the brake system 26 to prevent the vehicle 10 from exceeding the maximum allowed speed vₘᵢₙ. At block 116, solely when the current vehicle speed is equal to or less than the second speed value, the controller 34 deactivates the brake system 26.

Returning to block 114, if the current vehicle speed is not increasing past a fourth speed value after the propulsion system 20 has employed (i.e., activated) the DFCO, then the method 100 proceeds to block 118. At block 118, the controller 34 maintains the DFCO until the current vehicle speed drops to a fifth speed value. The fifth speed value is equal to the maximum allowed speed vₘₐₓ minus a fifth predetermined value (e.g., 3 mph). The fifth predetermined value may be greater than the first predetermined value and the second predetermined value to ensure that the controller 34 is allowed to react in time to prevent violations of the driver's thresholds. Solely when the current vehicle speed is equal to or less than the fifth speed value, the method 100 proceeds to block 104. Otherwise, the method 100 returns to block 114.

The detailed description and the drawings or figures are supportive and descriptive of the present teachings, but the scope of the present teachings is defined solely by the claims. While some of the best modes and other embodiments for carrying out the present teachings have been described in detail, various alternative designs and embodiments exist for practicing the present teachings defined in the appended claims.

What is claimed is:

1. A method to control a vehicle, comprising:
receiving, by a controller of the vehicle, a set speed, a maximum allowed speed, and a minimum allowed speed, wherein the maximum allowed speed and the minimum allowed speed define an allowed speed range;
commanding, by the controller, a propulsion system to produce a commanded axle torque to maintain the set speed;
monitoring a current vehicle speed of the vehicle;
determining, by the controller, whether the current vehicle speed is between a first speed value and a second speed value, wherein the first speed value is the minimum allowed speed plus a first predetermined value, and the second speed value is the maximum allowed speed minus a second predetermined value; and
in response to determining that the current vehicle speed is not between the first speed value and the second speed value, commanding, by the controller, the propulsion system to adjust the commanded axle torque in order to maintain the current vehicle speed within the allowed speed range;
wherein commanding, by the controller, the propulsion system to adjust the commanded axle torque includes:
determining whether the current vehicle speed is less than the first speed value; and
in response to determining that the current vehicle speed is less than the first speed value, commanding the propulsion system to continuously increase the commanded axle torque until the vehicle reaches a third speed value, wherein the third speed value is equal to the minimum allowed speed plus a third predetermined value, and the third predetermined value is greater than the first predetermined value.

2. The method of claim 1, wherein determining, by the controller, whether the current vehicle speed is between the first speed value and the second speed value includes determining that the current vehicle speed is less than the first speed value.

3. The method of claim 2, wherein commanding, by the controller, the propulsion system of the vehicle to adjust the commanded axle torque to modify the current vehicle speed to be between the first speed value and the second speed value includes commanding the propulsion system to increase the commanded axle torque to prevent the current vehicle speed to drop below the minimum allowed speed in response to determining that the current vehicle speed is less than the first speed value.

4. The method of claim 3, further comprising not allowing, by the controller, the commanded axle torque to decrease until the current vehicle speed is equal to or greater than the third speed value.

5. The method of claim 2, wherein determining, by the controller, whether the current vehicle speed is between the first speed value and the second speed value includes determining that the current vehicle speed is greater than the second speed value.

6. The method of claim 5, further comprising, in response to determining that the current vehicle speed is greater than the second speed value:
commanding the propulsion system to stop producing additional torque; and
commanding the propulsion system to employ deceleration fuel cut off (DFCO).

7. The method of claim 6, further comprising charging a battery of the vehicle using regenerative braking in response to determining that the current vehicle speed is greater than the second speed value.

8. The method of claim 7, further comprising determining whether the current vehicle speed is increasing past a fourth speed value after the propulsion system has employed the DFCO, wherein the fourth speed value is equal to the maximum allowed speed minus a fourth predetermined value, and the fourth predetermined value is less than the first predetermined value and the second predetermined value.

9. The method of claim 8, wherein determining whether the current vehicle speed is increasing past the fourth speed value after the propulsion system has employed the DFCO includes determining that the current vehicle speed is increasing past the fourth speed value, and the method further includes activating, by the controller, a brake system of the vehicle to prevent the vehicle from exceeding the maximum allowed speed in response to determining that the current vehicle speed is increasing past the fourth speed value.

10. The method of claim 9, further comprising:
determining that the current vehicle speed is equal to or less than the second speed value; and
deactivating the brake system in response to determining that the current vehicle speed is equal to or less than the second speed value.

11. A vehicle system for a motor vehicle, comprising:
a sensor system including a plurality of sensors;
a user interface configured to receive inputs;
a controller in communication with the sensor system and the user interface, wherein the controller is programmed to:
receive a set speed, a maximum allowed speed, and a minimum allowed speed, wherein the maximum allowed speed and a minimum allowed speed define an allowed speed range;
command a propulsion system to produce a commanded axle torque to maintain the set speed;
monitor in real time, by the controller, a current vehicle speed of the vehicle;
determine whether the current vehicle speed is between a first speed value and a second speed value, wherein the first speed value is the minimum allowed speed plus a first predetermined value, and the second speed value is the maximum allowed speed minus a second predetermined value;
command the propulsion system of the vehicle to adjust commanded axle torque to modify the current vehicle speed to be between the first speed value and the second speed value;
determine whether the current vehicle speed is less than the first speed value; and
in response to determining that the current vehicle speed is less than the first speed value, command the propulsion system to continuously increase the commanded axle torque until the vehicle reaches a third speed value, wherein the third speed value is equal to the minimum allowed speed plus a third predetermined value, and the third predetermined value is greater than the first predetermined value.

12. The vehicle system of claim 11, wherein the controller is further programmed to:
determine that the current vehicle speed is less than the first speed value;
command the propulsion system to increase the commanded axle torque to prevent the current vehicle speed to drop below the minimum allowed speed in response to determining that the current vehicle speed is less than the first speed value;
refrain from decreasing the commanded axle torque until the current vehicle speed is equal to or greater than the third speed value and the third predetermined value is greater than the second predetermined value;
determine the current vehicle speed is greater than the second speed value;
in response to determining that the current vehicle speed is greater than the second speed value, the controller is programmed to:
command the propulsion system to stop producing additional torque; and
command the propulsion system to employ deceleration fuel cut off (DFCO).

13. The vehicle system of claim 12, further comprising the propulsion system and a battery coupled to the propulsion system, wherein the controller is programmed to:
command the battery to charge battery using regenerative braking in response to determining that the current vehicle speed is greater than the second speed value; and
determine whether the vehicle is accelerating at a pace that will pass a fourth speed value after the propulsion system has employed the DFCO, wherein the fourth speed value is equal to the maximum allowed speed minus a fourth predetermined value, and the fourth predetermined value is less than the first predetermined value, the second predetermined value, and the third predetermined value.

14. The vehicle system of claim 13, further comprising a brake system in communication with the controller, wherein the controller is programmed to:
determine that the current vehicle speed is increasing past the fourth speed value;
activate the brake system to prevent the vehicle from exceeding the maximum allowed speed in response to determining that the current vehicle speed is increasing past the fourth speed value;
determine that the current vehicle speed is equal to or less than the second speed value; and
deactivate the brake system in response to determining that the current vehicle speed is equal to or less than the second speed value.

15. The vehicle system of claim 11, wherein the controller is programmed to determine that the current vehicle speed is less than the first speed value.

16. The vehicle system of claim 15, wherein the controller is programmed to command the propulsion system to increase the commanded axle torque to prevent the current vehicle speed to drop below the minimum allowed speed in response to determining that the current vehicle speed is less than the first speed value.

17. The vehicle system of claim 16, wherein the controller is programmed to not allow the commanded axle torque to decrease until the current vehicle speed is equal to or greater than the third speed value, the third speed value is equal to the minimum allowed speed plus the third predetermined value, and the third predetermined value is greater than the second predetermined value.

18. The vehicle system of claim 11, wherein the controller is programmed to determine that the current vehicle speed is greater than the second speed value.

19. The vehicle system of claim 18, wherein, in response to determining that the current vehicle speed is greater than the second speed value, the controller is programmed to:
command the propulsion system to stop producing additional torque;
command the propulsion system to employ deceleration fuel cut off (DFCO).

20. The vehicle system of claim 19, further comprising a battery coupled to the propulsion system, wherein the controller is programmed to charge a battery using regenerative braking in response to determining that the current vehicle speed is greater than the second speed value.
